(19) United States
(12) Patent Application Publication
(10) Pub. No.: US 2007/0039423 A1
(43) Pub. Date: Feb. 22, 2007

(54) Tool for servicing single-handle faucets

(76) Inventor: Pedro M. Guillermo JR., Glen Burnie, MD (US)

Correspondence Address: William S. Ramsey, 5253 Even Star Place, Columbia, MD, 21044, US

(21) Appl. No.: 11/208,863

(22) Filed: Aug. 22, 2005

(51) Int. Cl. B25B 13/48; B25B 13/56

(52) U.S. Cl. 81/176.15

(57) ABSTRACT

An exemplary embodiment providing one or more improvements includes a tool which greatly facilitates the disassembly and assembly of a single-arm faucet. Embodiments of the tool include a wrench end which is used to remove the adjusting ring from the top of the faucet. The faucet then can be readily disassembled using the compressor end of the tool and maintenance or repair accomplished. Reassembly involves use of the compressor end of the tool to compress the cam, which greatly facilitates the assembly process. Assembly is finished by use of the wrench end to engage and adjust the adjusting ring. Embodiments include a tool carrier. Other embodiments include an expander wrench attachment and a reducer wrench attachment which extend the utility of the tool to a wide variety of models of single-arm faucets.

### CROSS-REFERENCE(S)

Not Applicable.

### STATEMENT REGARDING FEDERALLY SPONSORED RESEARCH OR DEVELOPMENT

Not Applicable.

Reference to a “Microfiche Appendix”

Not Applicable.

### BACKGROUND

### DESCRIPTION OF RELATED ART INCLUDING INFORMATION DISCLOSED UNDER 37 CFR 1.97 AND 37 CFR 1.98

U.S. Pat. No. 5,542,321 discloses a wrench with two diameters for turning hex nuts or nuts having between 2 and 6 wrenching lugs for use in attaching faucet assemblies in place under the sink top.

U.S. Pat. No. 5,669,404 discloses a tool for replacing the diverted valve in a faucet.

U.S. Pat. No. 5,996,447 discloses a tubular pipe tool having slots for a nut engaging socket which has radially projecting studs. This tool is designed for under sink installation of a faucet assembly.

U.S. Pat. No. 6,257,099 discloses a tubular tool for under sink installation of a single lever faucet which has a nut receiving socket on one end and flutes and or texturing on the handle.

U.S. Pat. No. 6,698,317 discloses a tubular tool with rods reinforcing side walls adjacent to notches but which do not extend into the interior of the tube. Also there are ribs in a second socket which extend parallel to the longitude axis from an internal collar which slide into notches in a first tubular socket so the second socket rotates with the first.

U.S. Pat. No. 6,701,807 discloses a socket with an off-center slot for use in tightening and loosening nuts in the presence of an attached pipe.

Pub. US Pat. Applic. No. 2003/0131463 discloses a tool for removing and installing flanges which has a left hand thread and a frusto-conical wedge on one end.

Pub US Pat. Applic. No. 2005/0098001 discloses nested socket members having a handle with screwdriver bits.

The foregoing examples of the related art and limitations related therewith are intended to be illustrative and not exclusive. Other limitations of the related art will become apparent to those of skill in the art upon a reading of the specification and a study of the drawings.

### BRIEF SUMMARY

The following embodiments and aspects thereof are described and illustrated in conjunction with systems, tool and methods which are meant to be exemplary and illustrative, not limiting in scope. In various embodiments, one or more of the above described problems have been reduced or eliminated, while other embodiments are directed to other improvements.

Embodiments include tool comprising a tubular body, the body having a grip at the middle of the body, a wrench end comprising a wrench cylinder having a bore, at least one lug attached to the wrench cylinder wall inside the bore, and a compressor end comprising, a compressor cylinder having a bore, the external diameter of the compressor cylinder less than the external diameter of the wrench cylinder.

Other embodiments include an attachment to the to comprising a cylindrical tool holder comprised of resilient flexible material, the tool holder sized to fit into the bore of the wrench end, the tool holder having at least one slot in a first end to interact with the at least one lug of the wrench end cylinder, the tool holder having at least one cavity to hold tools.

Other embodiments include an expanded wrench attachment which comprises a first and a second end, the first end comprising a cylinder having a diameter capable of insertion into the wrench cylinder and at least one notch on the circumference of the first end cylinder capable of interaction with the at least one wrench cylinder lug, and a second end comprising an expanded wrench cylinder having a bore, and at least one lug attached to the expanded wrench cylinder wall inside the bore, the external diameter of the expanded wrench cylinder larger than the external diameter of the wrench cylinder.

Other embodiments include a reduced wrench attachment which comprises a first and a second end, the first end comprising a cylinder having a diameter capable of insertion into the wrench cylinder and at least one notch on the circumference of the first end cylinder capable of interaction with the at least one wrench cylinder lug, and a second end comprising an reduced wrench cylinder having a bore, and at least one lug attached to the reduced wrench cylinder wall inside the bore, the external diameter of the reduced wrench cylinder less than the external diameter of the wrench cylinder.

Other embodiments include a tool comprising a tubular body, the body having a grip at the middle of the body, a wrench end comprising a wrench cylinder having a bore, a truncated cone attached within the bore, at least one lug attached to the external surface of the truncated cone, and a compressor end comprising, a compressor cylinder having a bore, the external diameter of the compressor cylinder greater than the external diameter of the wrench cylinder.

In addition to the exemplary aspects and embodiments described above, further aspects and embodiments will become apparent by reference to the drawings and by study of the following descriptions.

### BRIEF DESCRIPTION OF THE DRAWINGS

FIG. 1 is a perspective view of an embodiment with a truncated cone at the wrench cylinder.

FIG. 2 is a perspective view of an embodiment with lugs attached to the bore of the wrench cylinder.

FIG. 3 is a perspective view of an expander wrench attachment.

FIG. 4 is a perspective view of a reducer wrench attachment.

FIG. 5 is a perspective view of an accessory holder and accessories.

FIG. 6 is a perspective view of a disassembled single-handle faucet.

FIG. 7 is a flow chart showing the steps of disassembling a single-handle faucet.

FIG. 8 is a flow chart showing the steps of assembling a single-handle faucet.

### DETAILED DESCRIPTION

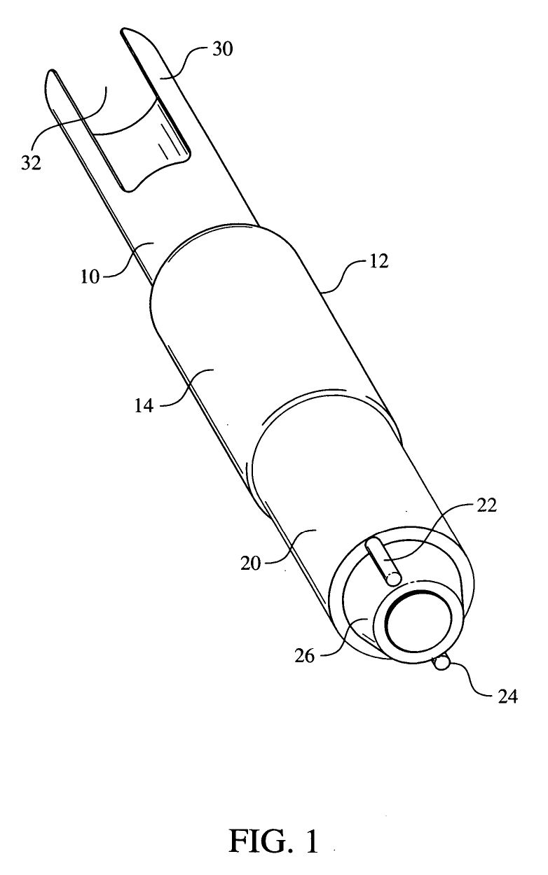

FIG. 1 is a perspective view of an embodiment 10 with a truncated cone at the wrench cylinder. Visible in FIG. I are the tubular body 12, and grip 14 which covers the tubular body, attached to a first end of the tubular body is the wrench cylinder 20, which has a truncated cone 26 fixedly attached within the bore of the wrench cylinder 20, and first lug 22 and second lug 24 fixedly attached at the ends of a diameter of the truncated cone on the external surface of the truncated cone. Also visible in FIG. 1 is the compressor cylinder 30 attached to a second end of the tubular body and a notch 32 in the compressor cylinder. In this embodiment the external diameter of the compressor cylinder 30 is larger than the external diameter of the wrench cylinder 20.

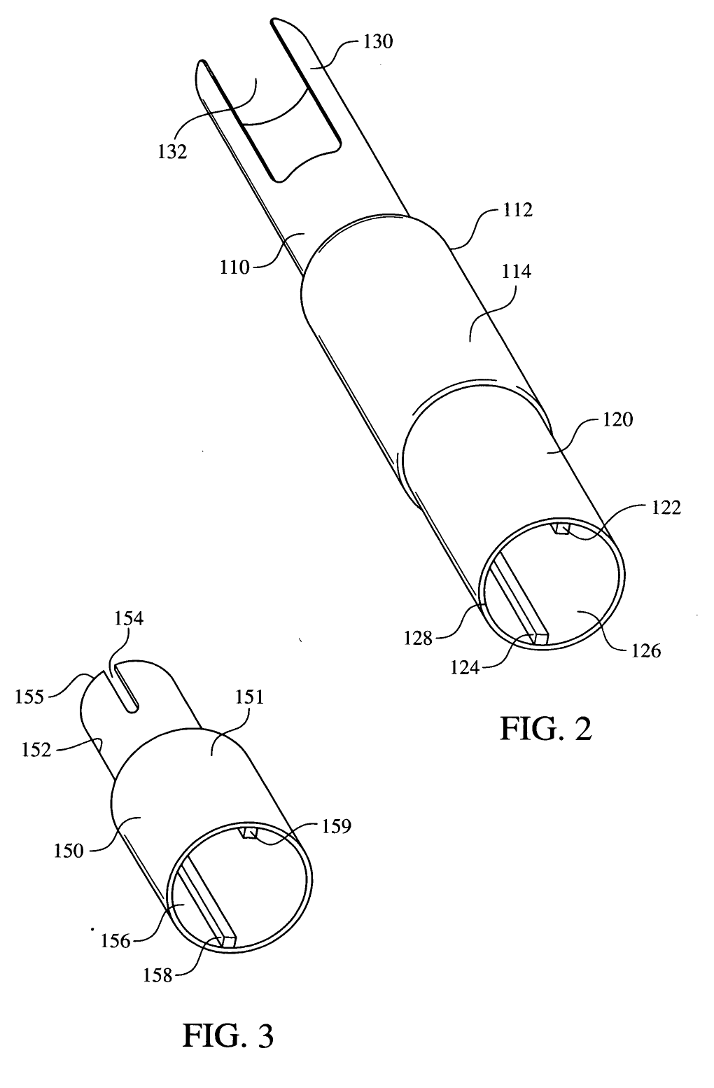

FIG. 2 is a perspective view of an embodiment 110 with lugs attached to the bore of the wrench cylinder. Visible in FIG. 2 are the tubular body 112, and grip 114 which covers the tubular body, attached to a first end of the tubular body is the wrench cylinder 120, with a bore 126, which has a first lug 122 and second lug 124 fixedly attached at the ends of a diameter of the bore on the internal surface of the wrench cylinder or on the surface of the bore. The ends of the lugs may be slightly displaced away from the end of the wrench cylinder, which the formation of a small apron 128 of wrench cylinder which extends beyond the lugs. This apron allows the frictional fit and retention of an adjusting ring after removal of the adjusting from the faucet. Also visible in FIG. 2 is the compressor cylinder 130 attached to a second end of the tubular body and a notch 132 in the compressor cylinder. In this embodiment the external diameter of the compressor cylinder 130 is smaller than the external diameter of the wrench cylinder 120.

FIG. 3 is a perspective view of an expander wrench attachment 150. Visible in FIG. 3 is wrench cylinder 151, with a bore 156, which has a first lug 158 and second lug 159 fixedly attached on the internal surface of the wrench cylinder or on the surface of the bore. Also visible in FIG. 3 is the expander attachment end 152 attached to a second end of the wrench cylinder and a first notch 154 in the expander attachment end. A second notch 155 not visible in FIG. 3 is at the end of a diameter of the bore with the first notch at the other end. In this embodiment the external diameter of the expander attachment end 152 is smaller than the external diameter of the wrench cylinder 151. The external diameter of the expander attachment end 152 is slightly less than the diameter of the bore 126 of the wrench cylinder 120 of the embodiment in FIG. 2. The expander attachment end 152 fits into the bore 126 of FIG. 2 and is restrained from rotation by interaction of the notches 154 and 155 with the lugs 124 and 122 in FIG. 2.

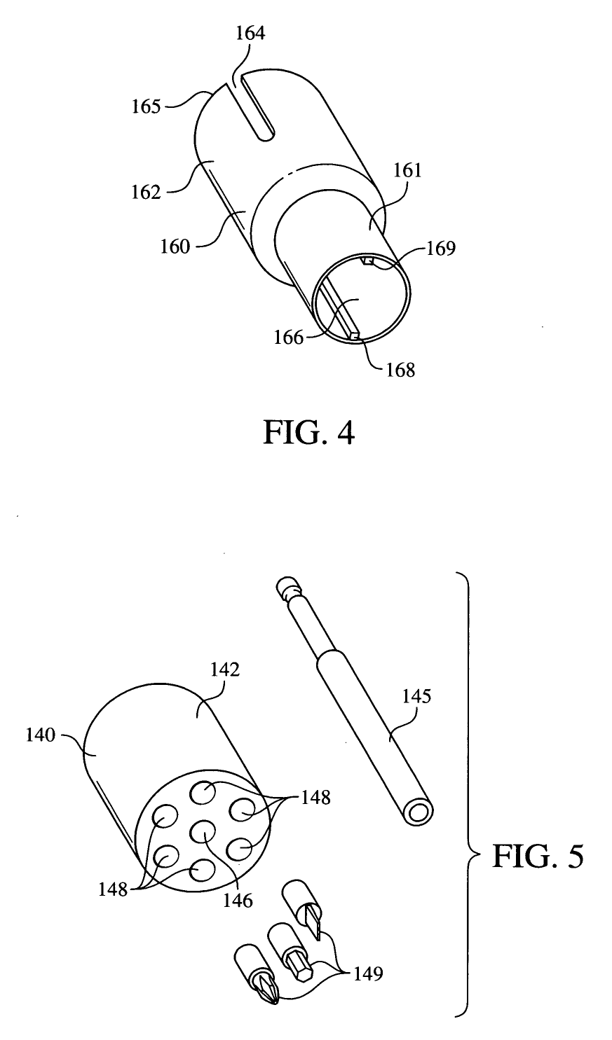

FIG. 4 is a perspective view of a reducer wrench attachment 160. Visible in FIG. 4 is wrench cylinder 161, with a bore 166, which has a first lug 168 and second lug 169 fixedly attached on the internal surface of the wrench cylinder or on the surface of the bore. Also visible in FIG. 4 is the reducer attachment end 162 attached to a second end of the wrench cylinder and a first notch 164 in the expander attachment end. A second notch 165 not visible in FIG. 4 is at the end of a diameter of the bore with the first notch at the other end. In this embodiment the external diameter of the reducer attachment end 162 is larger than the external diameter of the wrench cylinder 161. The external diameter of the reducer attachment end 162 is slightly less than the diameter of the bore 126 of the wrench cylinder 120 of the embodiment in FIG. 2. The reducer attachment end 162 fits into the bore 126 of FIG. 2 and is restrained from rotation by interaction of the notches 164 and 165 with the lugs 124 and 122 in FIG. 2.

FIG. 5 is a perspective view of an accessory holder 140 and accessories. Visible in FIG. 5 is the cylindrical accessory holder body 142 with approximately parallel holes 148 and 146 to accommodate accessory tools 149 and a screwdriver or wrench expander attachment 145, respectively. The diameter of the accessory holder is constructed to be slightly smaller than the internal diameter of the compression cylinders of the various embodiment tools and is retained in these cylinders by friction fit. The accessory tools are retained in the holes by friction fit.

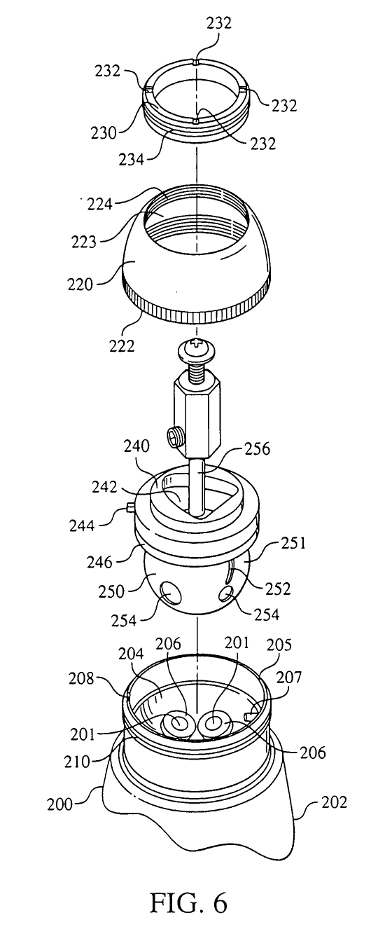

FIG. 6 is a perspective view of a disassembled single-handle faucet 200. Visible in FIG. 6 is the faucet body 202 and ball assembly chamber 204. The side of the body has threads 210 for use in removably attachment of the cap 222 by interaction with threads 222 on the underside of the cap and not visible in FIG. 6. The ball assembly chamber 204 has a chamber lip 205 at the top of the chamber with a cam tab slot 108 in the lip. Visible at the bottom of the ball assembly chamber are doughnut-shaped valve seats 206 which seal the water ports 201. A ball assembly pin 207 protrudes into the ball assembly chamber.

Also visible in FIG. 6 is the ball assembly 150. It comprises a ball 251 which is pierced by two fluid passages 254. A notch 252 on one side of the ball interacts with the ball assembly pin 207 on the ball assembly chamber wall. A ball assembly handle 256 is attached to the top of the ball.

Also visible in FIG. 6 is the cap 220. Underside threads 222 (not visible in FIG. 6) are on the inner surface of the bottom of the cap and interact with the threads 210 on the faucet body 202 to removably attach the cap to the faucet body. At the top of the cap is a hole 223 through which the ball assembly handle 256 protrudes when the faucet is assembled. The inner surface of the hole 223 has threads 224 which interact with threads 234 on the adjusting ring 230. The adjusting ring 230 has on its upper surface notches 232 which are arrayed equidistant on the circumference of the upper surface of the adjusting ring.

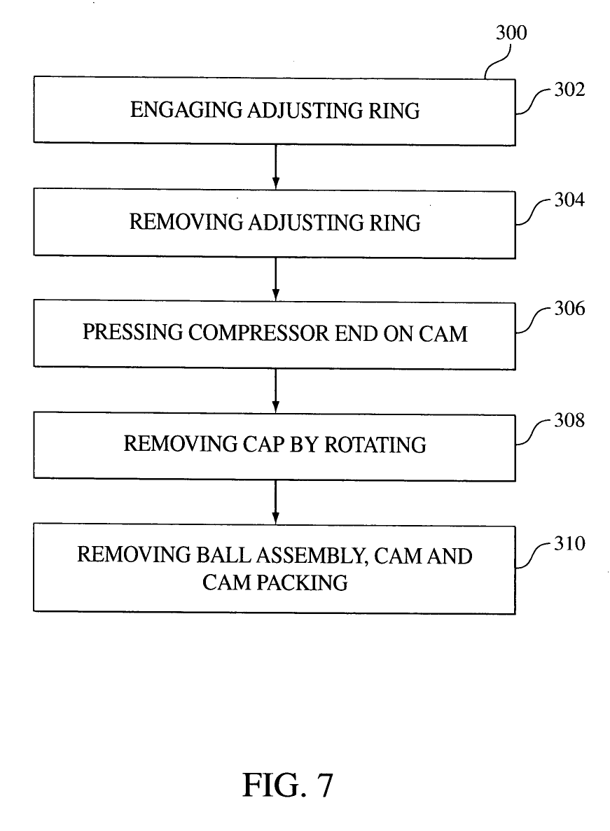

FIG. 7 is a flow chart showing the process 300 of disassembling a single-handle faucet. Such faucets require periodic disassembly for the purpose of repairing or replacing component parts, such as valve seats, valve seat springs, ball assembly, cam, cam packing, O rings, cap, adjusting ring or diverter assembly (spray models only).

In the first step 302 of the disassembly process the adjusting ring at the top of the faucet is engaged by the wrench end of the single-handle faucet tool with the lugs interacting with the adjusting ring notches. The tool is rotated in a counterclockwise direction with the removal of the adjusting ring from the cap 304. In some embodiments the adjusting ring is retained on the tool by friction of the wrench cylinder apron with the ring. The compressor end is then pressed 306 on the cam, thereby allowing the removal 308 of the cap by manual rotation in a counterclockwise direction. After the cap is removed, the ball assembly, cam, and cam packing is removed manually 310. This procedure provides access to all components of the single-arm faucet which require service.

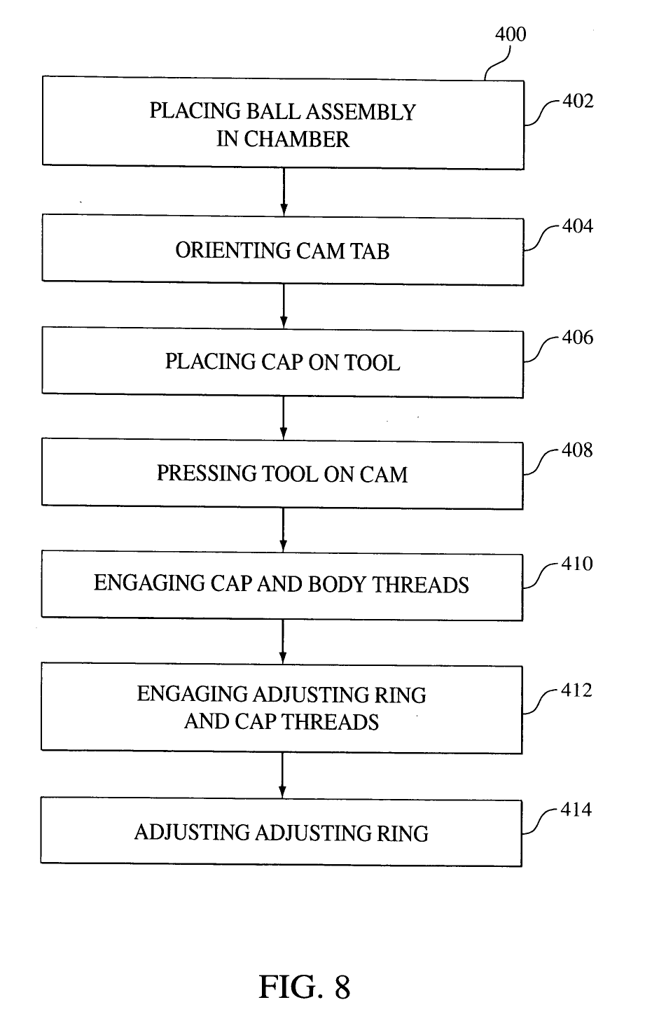

FIG. 8 is a flow chart showing the steps of assembling a single-handle faucet 400. In the first step 402 the ball assembly along with the cam and cam packing is placed in the ball assembly chamber, taking care to engage the chamber pin with the ball slot. In the second step 404 the cam tab is oriented with the cam slot on the chamber lip. In the third step 406 the cap is placed on the compressor end of the tool, with the top of the cap nearest the tool grip. The placement of the third step in the process is not important. It need only precede the fourth step. In the fourth step 408 the compressor end of the tool is pressed against the cam, thereby compressing the valve seats and pressing the cam tab into the cam slot. This enables the manual engaging 410 of the threads on the underside of the cap and the body threads through clockwise rotation of the cap. The adjusting ring is engaged 412 with the adjusting ring threads through clockwise rotation using the wrench end of the tool. In a final optional step 414 the adjusting ring is adjusted to insure smooth leak-proof operation by rotating the ring as necessary using the wrench end of the tool.

The expander and reducer attachments are used to extend the range of faucets which can be serviced using embodiments. In use, the first end of the attachments is inserted into the bore of the wrench end of an embodiment which has lugs attached to the bore. Interaction of the lugs and notches of the attachments prevent the rotation of the attachment with respect to the tool when the tool is rotated. The tool with attachment is then used as described for embodiments without attachments with the expanded or reduced wrench cylinders allowing the use of the tool with faucets having larger or smaller retaining ring diameters.

Embodiments of the tool are manufactured from any suitable strong hard material, such as steel, iron, copper, aluminum or hard plastics such as polycarbonates. The grip is manufactured from any suitable resilient, wear resistant material such as rubber or plastic.

Embodiments of the accessory holder are manufactured from any suitable resilient flexible material such as rubber or plastic polymers.

Embodiments of the tool may be used with virtually any single-handle faucet. In particular, embodiments may be used with kitchen, bath, and lavatory single-handle faucets.

Specific examples of faucets which may be serviced with embodiments include DELTA models RP3614 and SINGLE HANDLE PULLOUT SIGNATURE and SAXONY KITCHEN FAUCETS Models 470, 472, 473, 473-SD, 544-CBWF, and 540-WFMPU. Other examples include DELTA E-FLOW electronic lavatory or shower faucet. Other examples include PEERLESS Model P8620 Series faucets. Other examples include Huntington HB5510 Chrome or Brass faucets. Other examples include B&K Series IV Plus Kitchen Sink Faucet. Other examples include PREMIER vanity and kitchen faucets. Other examples include PRO-FLO vanity and kitchen faucets. Other examples include VILLETE vanity and kitchen faucets. Other examples include WIL-FLO vanity and kitchen faucets. Other examples include ACCESS vanity and kitchen faucets. Other examples include GLAZIER BAY vanity and kitchen faucets. Other examples include OAK BROOKS vanity and kitchen faucets. Other examples include PRO PLUS vanity and kitchen faucets. Other examples include WESTERN PRIDE vanity and kitchen faucets.

While a number of exemplary aspects and embodiments have been discussed above, those of skill in the art will recognize certain modifications, permutations, additions and subcombinations thereof. It is therefore intended that the following appended claims and claims hereafter introduced are interpreted to include all such modifications, permutations, additions and sub-combinations as are within their true spirit and scope.

I claim:

1. A tool comprising:
a tubular body,
a grip at the middle of the body,
a wrench end comprising
a wrench cylinder having a bore,
at least one lug, and
a compressor end comprising,
a compressor cylinder having a bore.

2. The tool of claim 1 wherein the at least one lug is attached to the wrench cylinder wall inside the bore and the external diameter of the compressor cylinder is less than the external diameter of the wrench cylinder.

3. The tool of claim 2 further comprising:
an expanded wrench attachment comprising a first and a second end,
the first end comprising a cylinder having a diameter capable of insertion into the wrench cylinder and at least one notch on the circumference of the first end cylinder capable of interaction with the at least one wrench cylinder lug, and
a second end comprising an expanded wrench cylinder having a bore, and
at least one lug attached to the expanded wrench cylinder wall inside the bore,
the external diameter of the expanded wrench cylinder larger than the external diameter of the wrench cylinder.

4. The tool of claim 2 further comprising:
a reduced wrench attachment comprising a first and a second end,
the first end comprising a cylinder having a diameter capable of insertion into the wrench cylinder and at least one notch on the circumference of the first end cylinder capable of interaction with the at least one wrench cylinder lug, and
a second end comprising an reduced wrench cylinder having a bore, and
at least one lug attached to the reduced wrench cylinder wall inside the bore,
the external diameter of the reduced wrench cylinder less than the external diameter of the wrench cylinder.

5. The tool of claim 2 further comprising a truncated cone attached to the inside of the cylinder bore, the truncated cone having the at least one lug attached to its external surface, and the external diameter of the compressor cylinder is greater than the external diameter of the wrench cylinder.

6. The tool of claim 1 having two lugs.

7. The tool of claim 1 having a notch in the compressor end cylinder.

8. The tool of claim 1 wherein the grip is made of rubber.

9. The tool of claim 1 further comprising:
a cylindrical accessory holder comprised of resilient flexible material,
the accessory holder sized to fit into the bore of the wrench end or into the compressor cylinder bore,
the accessory holder having at least one cavity to hold an accessory.

10. The accessory holder of claim 9 wherein the accessory holder is made of rubber.

11. The accessory holder of claim 9 wherein the accessories are at least one screwdriver shaft and at least one bit.

12. The process of disassembling a single-arm faucet comprising the steps:
a. engaging at least one adjusting ring notch with at least one lug on the wrench end of a single-arm faucet wrench,
b. removing the adjusting ring by rotating the wrench in a counterclockwise direction,
c. pressing the compressor end of a single-lever faucet wrench against the cam,
d. removing the cap by rotating the cap in a counterclockwise direction, and
e. removing the ball assembly, cam, and cam packing from the ball assembly chamber.

13. The process of assembling a single-arm faucet comprising the steps:
a. placing the ball assembly in the ball assembly chamber while engaging the chamber pin with the ball slot,
b. orienting the cam tab over the cam tab slot on the chamber lip,
c. placing the cap on the compressor end of a single-lever faucet wrench,
d. pressing the compressor end of the single-lever faucet wrench against the faucet cam with engagement of the cam tab in the cam tab slot on the chamber lip,
e. engaging the cap underside threads with the body threads by rotating the cap in a clockwise direction, and
f. engaging the adjusting ring threads with the cap top threads by rotating the adjusting ring in a clockwise direction using the wrench end of a single-arm faucet tool.

14. The process of claim 12 further comprising the step:
g. adjusting the adjusting ring using the wrench end of the single-lever wrench.
